(19) United States
(12) Patent Application Publication
(10) Pub. No.: US 2019/0019201 A1
(43) Pub. Date: Jan. 17, 2019

(54) DISPLAY APPARATUS AND NON-TRANSITORY COMPUTER READABLE MEDIUM STORING PROGRAM

(71) Applicant: FUJI XEROX CO., LTD., Tokyo (JP)

(72) Inventors: Norihiro WADA, Kanagawa (JP); Wenjin ZHANG, Kanagawa (JP)

(73) Assignee: FUJI XEROX CO., LTD., Tokyo (JP)

(21) Appl. No.: 16/025,173

(22) Filed: Jul. 2, 2018

(30) Foreign Application Priority Data
Jul. 14, 2017 (JP) 2017-137709

(51) Int. Cl. G06Q 30/02; G06Q 30/06; G06Q 10/10

(52) U.S. Cl. CPC G06Q 30/0201; G06Q 10/10; G06Q 30/0617

(57) ABSTRACT

A display apparatus acquires a history of view of information items related to products by a customer and information indicating a product that is not being provided to the customer or/and information indicating a product that is being provided to the customer, and displays, by using the history and the information, information related to the product that is not being provided to the customer among the products identified based on the history.

### CROSS-REFERENCE TO RELATED APPLICATIONS

This application is based on and claims priority under 35 USC 119 from Japanese Patent Application No. 2017-137709 filed Jul. 14, 2017.

### BACKGROUND

### (i) Technical Field

The present invention relates to a display apparatus and a non-transitory computer readable medium storing a program.

### (ii) Related Art

Access analysis has often been performed on a web page in a website to evaluate the website or the web page.

Evaluation has also been made on the configuration of an electronic commerce (E-commerce) site in relation to a purchase record.

### SUMMARY

According to an aspect of the invention, there is provided a display apparatus that acquires a history of view of information items related to products by a customer and information indicating a product that is not being provided to the customer or/and information indicating a product that is being provided to the customer, and displays, by using the history and the information, information related to the product that is not being provided to the customer among the products identified based on the history.

### BRIEF DESCRIPTION OF THE DRAWINGS

An exemplary embodiment of the present invention will be described in detail based on the following figures, wherein:

FIG. 1 illustrates an example of a system to which a mechanism of one exemplary embodiment of the present invention is applied;

FIG. 2 illustrates an example of data items on service providing statuses of each customer that are held in a customer DB;

FIG. 3 illustrates an example of data held in a service DB;

FIG. 4 illustrates an example of data held in a sales representative DB;

FIG. 5 exemplifies the functional configuration of a sales information system;

FIG. 6 schematically illustrates an example of display of a list screen;

FIG. 7 schematically illustrates another example of the display of the list screen;

FIG. 8 schematically illustrates an example of display of a details screen;

FIG. 9 illustrates an example of a processing procedure of the system of the exemplary embodiment;

FIG. 10 illustrates an example of a system including a material DB for generating a proposal material for a customer;

FIG. 11 illustrates an example of template information in the material DB;

FIG. 12 illustrates an example of a proposal document of a certain proposal target service for a general affairs department;

FIG. 13 illustrates an example of the proposal document of the certain proposal target service for a system department;

FIG. 14 illustrates an example of the template information in the material DB; and

FIG. 15 illustrates an example of a document of a practical case of a proposal target service that is incorporated in a proposal material for a customer and is applied to the same business as that of the customer.

### DETAILED DESCRIPTION

### <Description of Technical Terms>

Technical Terms Used Herein are Described.
(1) The concept of “product” is not limited to a commodity but encompasses software and a service.
(2) “Information items related to products” are information items that are related to the products and are viewable by a customer. Examples of the “information items related to products” include a web page that describes the product, a web page that describes a system obtained by using the product, and a web page that introduces a practical case of the product. A relation between a product and an information item or the degree of the relation may be defined in advance or determined by analyzing contents of each information item. The “information item” is not limited to the information item in the form of a web page. For example, the “information item” may be a file or each data item registered in a database.
(3) A state in which the product is “being provided” may refer to a state within a service providing period that is defined for the product in a contract between a product provider and a customer. A typical example thereof is a case in which the provider and the customer have made a contract to provide a service within a certain period. When the provider has sold the product to the customer in response to payment from the customer, the product is “being provided” after the product has been sold. In this case, a period in which the product is “being provided” may be limited to, for example, a period before a usable period or a useful life of the product is ended. When a maintenance service contract has been made for the sold product, the period defined in the maintenance service contract may be assumed as the period in which the product is “being provided”.
(4) “Information indicating a product that is not being provided to the customer or/and information indicating a product that is being provided to the customer” may be any type of information as long as the information may identify the product that is not being provided to the customer. Examples of the “information” include a list of products that are not being provided to the customer. In a list of products that are being provided to the customer from the provider, it may be determined that products that are not included in the list are not being provided to the customer. Therefore, this list corresponds to “information related to the product that is not being provided to the customer”. Examples of the “information” also include information indicating whether each product that may be provided by the provider is being provided to the customer.
(5) An operation in which the display apparatus “displays” the information related to the product includes not only an operation in which the display apparatus displays the information on its screen but also an operation in which the display apparatus displays the information on a screen of a different apparatus via a network (that is, provides data necessary to display the information on the “different apparatus”).

### Exemplary Embodiment

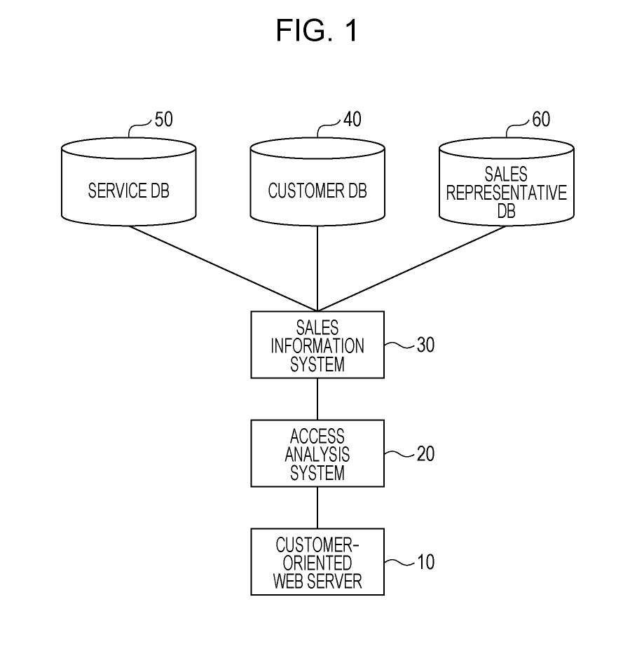

FIG. 1 illustrates an example of a system to which a mechanism of one exemplary embodiment of the present invention is applied. For example, this system provides information on a customer to a staff member in a provider company (for example, a sales representative for a customer) that provides a product in a business-to-business (B to B) relationship. The customer may be a company or a specific department in a company. To simplify the description, the product that is provided to the customer from the provider company is hereinafter a service. The provider company and the customer make a contract to provide the service and the provider company provides the service to the customer under the contract.

A customer-oriented web server 10 is a web server that is operated by the provider company in order to provide information to the customer. The customer-oriented web server 10 provides, to a user (for example, an employee of a customer company), a group of web pages (hereinafter referred to simply as “pages” as well) that provide various types of information on products handled by the provider company. For example, the web page group may include a page that describes an overview of various services, a page that describes details of contents of various services, a page that introduces technologies used for the services, a page that describes a system obtained by combining plural services, a page that proposes addressing a problem by using one or more services, and a page that introduces a practical case of a service.

The user completes user registration on the customer-oriented web server 10 in advance. In the user registration, information on the customer (company or department) to which the user belongs is registered as one attribute of the user. The customer-oriented web server 10 authenticates the user who has accessed the customer-oriented web server 10 to recognize that the user has accessed (viewed) a certain web page at a certain timing. The customer-oriented web server 10 records the recognized information items as an access (view) history in an access log database (not illustrated).

An access analysis system 20 analyzes an access history of a user group for the customer-oriented web server 10 and sums up access statuses of the users (employees of the customer company) for the respective web pages in the customer-oriented web server 10 within a specified analysis period. It is appropriate that the access statuses for the respective pages be summed up by using related art. For example, an access count of each page within the latest period of a predetermined length may be determined as the access status or a cumulative access count obtained while assigning a greater weight to accesses near the present may be determined as the access status.

An external access analysis system such as Google (registered trademark) Analytics may be used instead of or in addition to providing the access analysis system 20 in the entire system of the exemplary embodiment as illustrated in FIG. 1.

The access analysis system 20 may substitute for a customer-specific summation part 312 described later to sum up access statuses on a customer basis.

A sales information system 30 uses an analysis result from the access analysis system 20 and data held in a customer database (DB) 40, a service DB 50, and the like to generate information on sales for the customer that is provided to a representative person (for example, a sales representative) in the provider company.

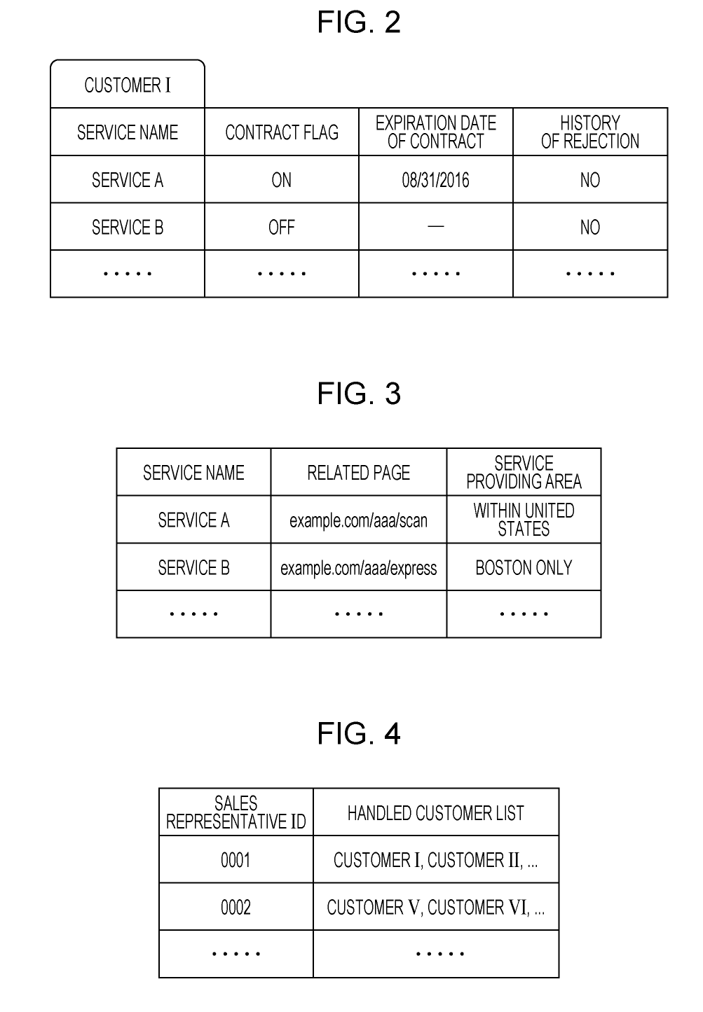

Management information of each customer is registered in the customer DB 40. FIG. 2 exemplifies information items on service providing statuses of a customer having an identification name “customer I”. Those information items are registered in the customer DB 40. In FIG. 2, the service providing statuses of the customer I are represented in a table format. In this example, the information items on the service providing statuses include items such as a “service name”, a “contract flag”, an “expiration date of contract”, and a “history of rejection” for each service that may be provided to a customer group from the provider company. The “service name” is an identification name (identification information) of the service. The “contract flag” is a binary (ON or OFF) flag indicating whether the service is under the contract (that is, the service is being provided to the customer from the provider company). The value “ON” of the flag means that the service is under the contract and the value “OFF” means that the service is not under the contract (that is, the service is not being currently provided to the customer). The “expiration date of contract” is a date until which the contract of the service is effective. The provider company provides the service to the customer until the expiration date of contract. The expiration date of contract is determined by the contract. The “history of rejection” indicates, for example, whether the sales representative of the provider company has proposed the service to the customer but the customer has made a request (proposal rejection request) to stop the proposal for the service from then on (at least for a while) (because of no interest in the service). The value of this item is “YES” when the proposal rejection request has been received or “NO” when the proposal rejection request has not ever been received. The system avoids proposing the service to the customer when this item is “YES”. When the “history of rejection” is “YES”, the date of the proposal rejection request may be recorded together and the value of the “history of rejection” may be switched to “NO” after a predetermined period has elapsed from that date (that is, the proposal may be made again after a certain length of time has elapsed from the time of request).

Data other than the data exemplified in FIG. 2 is also registered in the customer DB 40. For example, member user information of each customer is an example of the data. The member user information includes, for each customer, information on each user who belongs to the customer (for example, user identification information registered in the customer-oriented web server 10). Further, a location, a business type, a size, and other attribute information of the customer are registered in the customer DB 40.

The service DB 50 holds attribute information of each service. In an example of FIG. 3, items such as a “service name”, a “related page”, and a “service providing area” are held for each service. The service name is an identification name of the service.

Identification information of a page related to the service among the web pages in the customer-oriented web server 10 is stored in the “related page” field. The page related to the service may include various pages such as a page that describes an overview of the service, a page that describes detailed information on the service, a page that introduces a practical case of the service, and a page that describes a combined service that is a combination of the service with one or more different services. When plural related pages are provided for one service, identification information items of the plural pages are registered in the “related page” field. The degrees of relation to the service may differ between the pages related to the service. Therefore, numerical values indicating the degrees of relation of the pages to the service may be registered in association with the identification information items of the pages registered in the “related page” field. When results of summation of accesses to the pages that are obtained by the access analysis system 20 are converted into index values indicating the degrees of interest to the customer in each service, the degrees of relation of the pages to the service may be used in calculation.

Information indicating an area where the service may be provided is registered in the “service providing area” field. When the sales information system 30 selects a service to be proposed to the customer, the sales information system 30 excludes, from proposal target services, such a service that the location of the customer is not included in the service providing area.

Description is herein given of the exemplary case in which the service is provided with a limitation of an area. The service may be provided with limitations other than the limitation of the area. For example, the service may be provided with a limitation of a business type as in a case in which the service may be provided to an education-related customer but is not provided to a finance-related customer.

For each sales representative who belongs to the provider company, identification information of the sales representative (sales representative ID) and a list of identification information items of customers handled by the sales representative (handled customer list) are registered in a sales representative DB 60. The sales representative DB 60 may be used for controlling accesses to customer information of the sales representative who uses the sales information system 30.

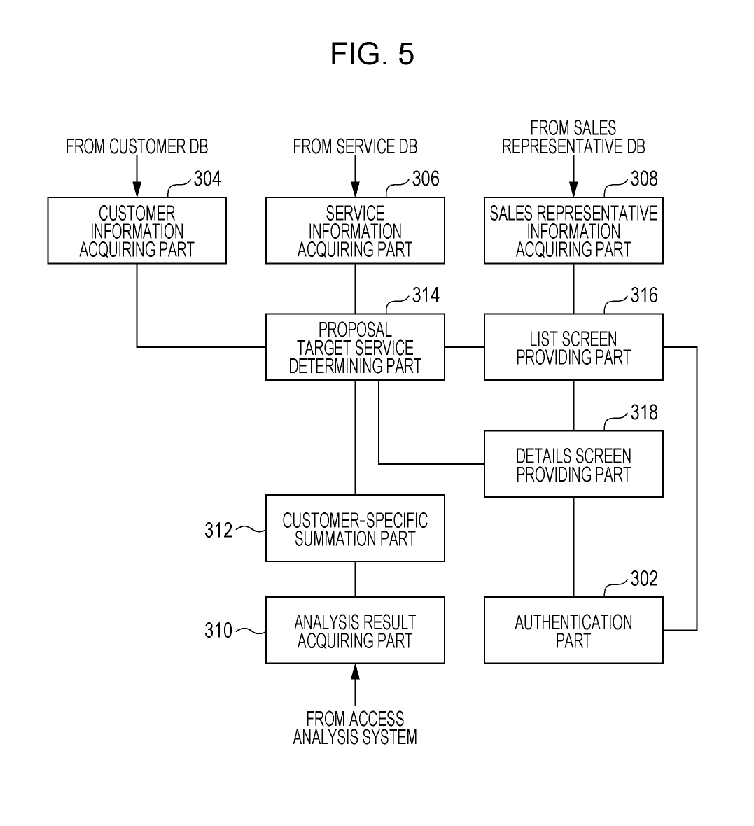

Next, the functional configuration of the sales information system 30 is exemplified with reference to FIG. 5. In the example of FIG. 5, the sales information system 30 includes an authentication part 302, a customer information acquiring part 304, a service information acquiring part 306, a sales representative information acquiring part 308, an analysis result acquiring part 310, the customer-specific summation part 312, a proposal target service determining part 314, a list screen providing part 316, and a details screen providing part 318.

The authentication part 302 authenticates the user who accesses the sales information system 30 (person such as a sales representative who belongs to the provider company). The user who fails in the authentication is not allowed to use the sales information system 30.

The customer information acquiring part 304 acquires information from the customer DB 40. The service information acquiring part 306 acquires information from the service DB 50. The sales representative information acquiring part 308 acquires information from the sales representative DB 60.

The analysis result acquiring part 310 acquires an analysis result from the access analysis system 20. The customer-specific summation part 312 determines access statuses of each customer by summing up, on a customer basis, access statuses of the users (employees of the customer or the like) that correspond to the analysis result from the access analysis system 20. The access status of each customer is frequency information indicating how many times the customer (that is, all the employees of the customer) has accessed each page in the customer-oriented web server 10 within the analysis period specified in advance.

The proposal target service determining part 314 determines a service to be proposed to each customer based on the access statuses of each customer for the customer-oriented web server 10 that are determined by the customer-specific summation part 312. In this determination, services that attract high degrees of interest to the customer (that is, services each indicating that the frequency of access to the related page is equal to or higher than a threshold) are identified based on the access statuses of the customer for the customer-oriented web server 10 and information items on relations between the services and the web pages that are held in the service DB 50. The identified services are referred to as high-interest services. The proposal target service determining part 314 refers to the service providing statuses of the customer that are held in the customer DB 40 (see FIG. 2) to search among the identified high-interest services for a service that is not being provided to the customer (that is, a service indicating that the contract flag is “OFF”). When a service that satisfies the condition is found, the proposal target service determining part 314 extracts the found service as a proposal target service, which is a service to be proposed to the customer. The proposal target service herein refers to a service to be proposed for its introduction to the customer by the provider company (for example, a sales representative of the provider company). In this exemplary embodiment, a service that is a high-interest service and is not being provided to the customer is extracted as the proposal target service. Information on the extracted proposal target service is supplied to the list screen providing part 316 and the details screen providing part 318.

The list screen providing part 316 provides a list screen that displays a list of statuses of customers to the user (sales representative of the provider company or the like) of the sales information system 30.

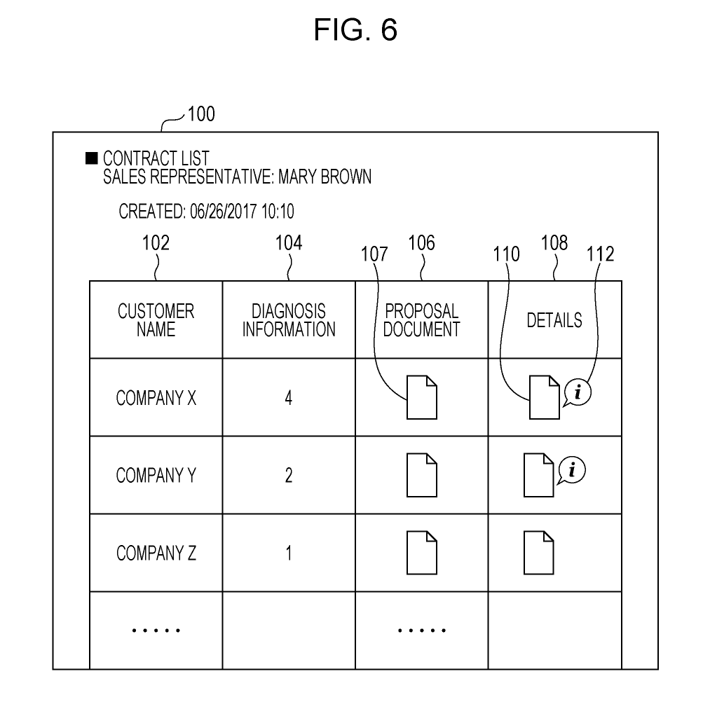

FIG. 6 illustrates an example of a list screen 100 to be provided by the list screen providing part 316. In this example, the list screen 100 is provided to a sales representative (name: “Mary Brown”). In the list screen 100, information items on customers handled for sales by the sales representative (referred to as handled customers) are displayed as a list. The customers handled by the sales representative are identified based on the data in the sales representative DB 60 (see FIG. 4). For example, the list screen 100 is configurated as a web page and is displayed by being transferred from the list screen providing part 316 to a web browser of a user's PC.

The information items on each customer in the list screen 100 include items such as a customer name 102, a diagnosis information 104, a proposal document 106, and details 108. The customer name 102 is an identification name of the customer (company or the like).

The diagnosis information 104 is information indicating a result of diagnosis of a status of the customer related to a service group provided by the provider company. For example, the diagnosis is performed by using various types of information indicating the conditions of a group of devices and software that are automatically transmitted for maintenance from the devices and software to a management server of the provider company. The devices and software are installed in an office of the customer in order to provide services from the provider company. For example, the diagnosis is made on a hardware environment or a security environment. In FIG. 6, numerical values of overall diagnosis levels of customer environments are displayed in the fields of the diagnosis information 104 as an example in order to avoid complexity.

Links 107 to document files of proposal materials to be provided to the customers by the sales representative are displayed in the fields of the proposal document 106. For example, the proposal material includes detailed description of the diagnosis result described above and a proposal for a measure against a problem that is shown in the diagnosis result. Further, the proposal material includes description of the proposal target service extracted by the proposal target service determining part 314. The sales information system 30 automatically generates the proposal material by, for example, a method that involves applying information on the diagnosis result to a document template of the proposal material. The user of the sales information system 30 selects the link 107 by clicking or the like to open the document file of the proposal material and display the document file on the screen. The sales information system 30 receives editing performed by the user on the opened document file and outputs the document file by printing in response to a user's print instruction.

Links 110 to details screens of the customers are included in the fields of the details 108. When the user selects the link 110 by clicking or the like, a details screen 150 described later is provided to the user. For a customer whose proposal target service has been detected by the proposal target service determining part 314, a mark 112 indicating that the proposal target service is present is displayed in the details 108. For the customer with the mark 112, an unprovided high-interest service (proposal target service) is present and therefore this customer is assigned with a high priority as a target of sales activities. The user (sales representative or the like) may identify the customer having a high priority based on the presence or absence of the mark 112.

The list screen providing part 316 may determine the order of the information items on the customers in the list screen 100 so that a customer with a proposal target service (that is, a customer with the mark 112) is ranked in a higher place than a customer with no proposal target service. With this setting, the information on the customer with a proposal target service is displayed near the top of the list screen 100 and is easily recognized by the user.

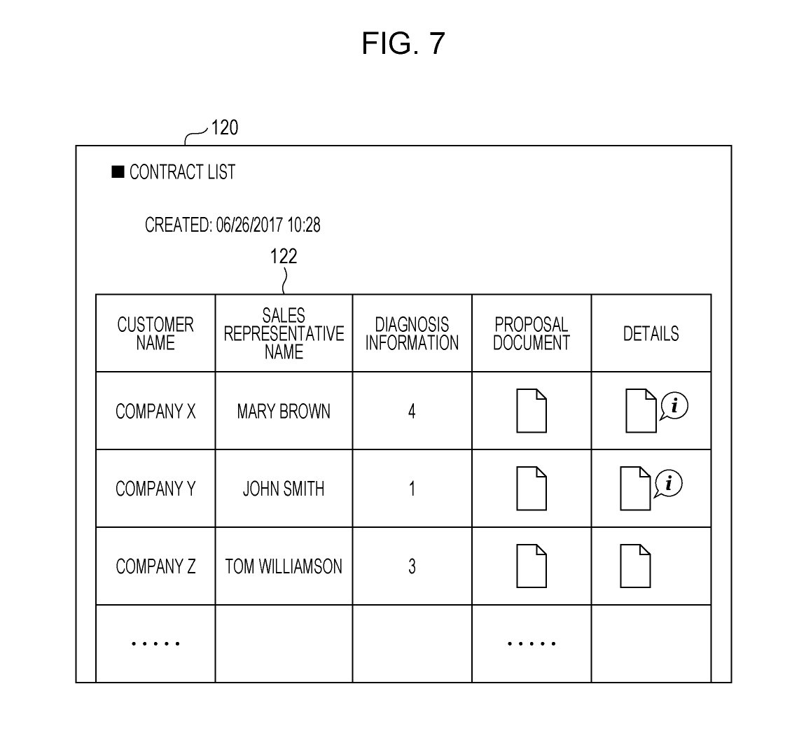

In the list screen 100 exemplified in FIG. 6, only the information items on the customers handled by each sales representative are displayed as a list. As exemplified in FIG. 7, the list screen providing part 316 may provide a list screen 120 in which customers handled by plural sales representatives are displayed as a list. The list screen 120 includes an item of a sales representative name 122. This item indicates a name of a sales representative who handles a customer in the same row. The other items are similar to those of the list screen 100 in FIG. 6. For example, the list screen providing part 316 provides, to a manager of a sales department, the list screen 120 that displays information items on customers handled by sales representatives managed by the manager.

Description is given again with reference to FIG. 5. The details screen providing part 318 provides, to the user (sales representative or the like), the details screen 150 that displays details of access statuses of a customer for the customer-oriented web server 10.

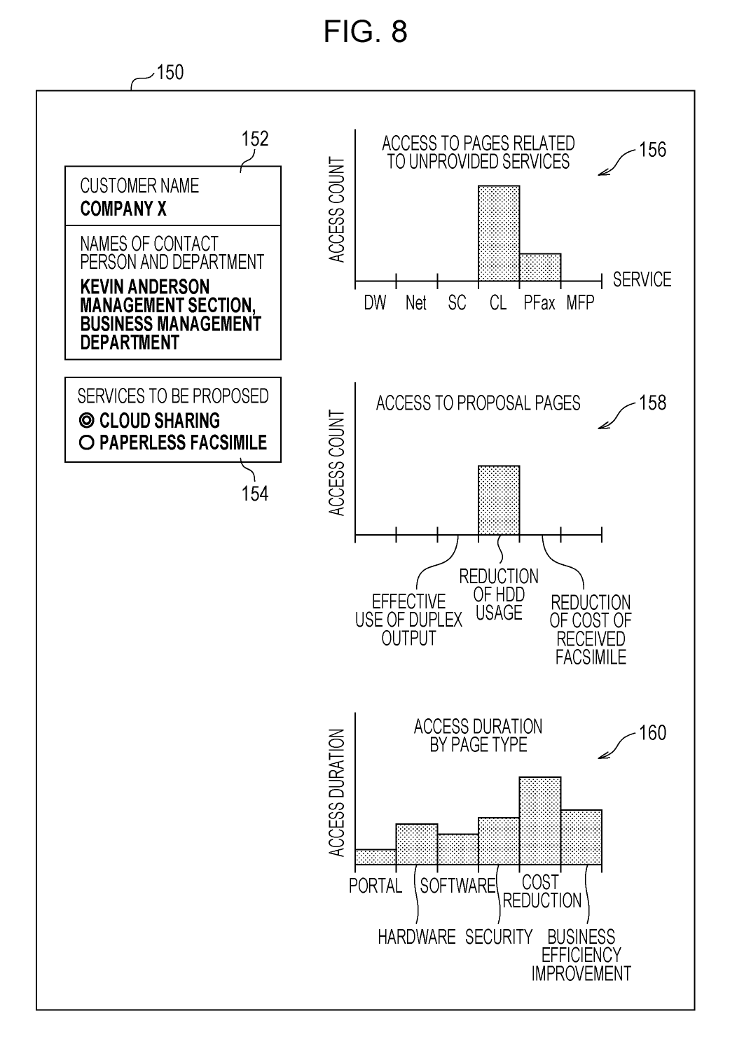

FIG. 8 illustrates an example of the details screen 150 of a customer that is provided by the details screen providing part 318. The details screen 150 includes a customer information display field 152, a proposal target service display field 154, a service access display field 156, a proposal page access display field 158, and a type-specific access duration display field 160. For example, the details screen 150 is configurated as a web page and is displayed by being transferred from the details screen providing part 318 to the web browser of the user's PC.

A name of a customer (company name) and a name of a contact person in the customer of the provider company are displayed in the customer information display field 152. A name of a proposal target service determined by the proposal target service determining part 314 is displayed in the proposal target service display field 154. When plural proposal target services are present, those proposal target services are displayed as a list.

A graph of an access status for each proposal target service (that is, a result of summation of an access status for a web page group related to the proposal target service) is displayed in the service access display field 156. In the illustrated example, the access status for each proposal target service is displayed in the form of a bar graph in which the horizontal axis represents each service (FIG. 8 illustrates a code of each service) and the vertical axis represents an access count of a page group related to the service. In the horizontal axis, all the services that may be provided by the provider company are displayed as a list and the bar graph of an access count is displayed only for the proposal target service determined by the proposal target service determining part 314 among the services. Bar graphs of access counts are not displayed for the services other than the proposal target service even if related page groups are accessed. By displaying the graph of only the access status for the proposal target service in the service access display field 156, information related to the proposal target service is explicitly conveyed to the user (sales representative or the like).

As another example, the bar graphs of access counts of related page groups may be displayed in the service access display field 156 for the services other than the proposal target service and the bar graph for the proposal target service may be displayed in a format distinguishable from the bar graphs for the services other than the proposal target service (for example, using different colors or patterns).

A graph of an access status for a web page corresponding to a “proposal page” category (but limited to a page related to the proposal target service) is displayed in the proposal page access display field 158. The proposal page refers to a page that describes a possible problem and a specific measure indicating the use of a certain service and the way to use the service to address the problem among the web pages in the customer-oriented web server 10. The customer-oriented web server 10 has plural pages corresponding to the proposal pages and titles of the proposal pages are arranged in the horizontal axis of the proposal page access display field 158. The vertical axis represents an access count of the proposal page. In the illustrated example, bar graphs of accesses are not displayed for pages related to a service other than the proposal target service even if the pages are proposal pages accessed by a user in the customer in the analysis result from the access analysis system 20. In the illustrated example, a bar graph of an access count is displayed for one proposal page in the proposal page access display field 158. This proposal page is related to a proposal target service “CL” (service name: “cloud sharing”) displayed in the service access display field 156. Similarly to the case of the service access display field 156, the bar graphs of access counts of the proposal pages that are not related to the proposal target service may be displayed in the proposal page access display field 158 in a format distinguishable from the bar graph for the proposal page related to the proposal target service.

A graph indicating a distribution of access counts are displayed in the type-specific access duration display field 160 for the respective types of contents of the web pages in the customer-oriented web server 10. Examples of the types of contents of the web pages include a portal, hardware, software, and security. In the type-specific access duration display field 160, accesses to all the web pages are measured as access counts for the respective types irrespective of whether the pages are related to the proposal target service. The sales information system 30 generates the graph to be displayed in the type-specific access duration display field 160 by referring to information on correspondence between the web pages and the types. For example, the type-specific access duration display field 160 is useful when the user (sales representative or the like) grasps the field (type of web page) of interest to the customer.

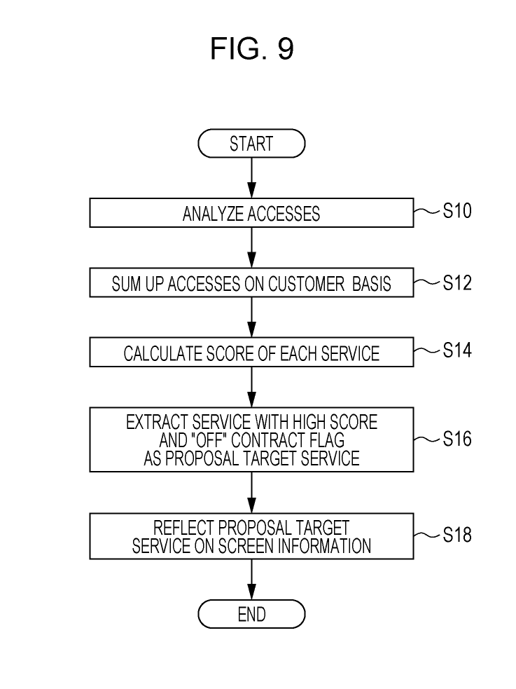

Next, a processing procedure of the system of this exemplary embodiment is described with reference to FIG. 9.

For example, the processing procedure is executed periodically or in response to a display instruction from the user (sales representative or the like). When the processing procedure has started, the sales information system 30 causes the access analysis system 20 to analyze access statuses of the users (employees of the customer or the like) for the respective web pages in the customer-oriented web server 10 within a predetermined latest period from the time when the processing has started (for example, one month). Next, the sales information system 30 causes the customer-specific summation part 312 to sum up the access statuses of the users on a customer basis (S12).

Next, the proposal target service determining part 314 executes processing of S14 to S18 on a customer basis. That is, the proposal target service determining part 314 first sums up, on a service basis, results of summation of the access statuses of the customer (in this stage, the results show accesses to the web pages) by referring to the service DB 50 (see FIG. 3), thereby calculating a score indicating the degree of interest to the customer in each service (S14). For example, the score indicating the degree of interest to the customer in a certain service is a sum of the access counts of the users in the customer (employees or the like) for a web page group corresponding to the service within a specified period. Next, the proposal target service determining part 314 extracts, as a proposal target service among the respective services, a service that has a high score (that is, the score is equal to or higher than a threshold) and is not being provided to the customer based on the data on the service providing status in the customer DB 40 (see FIG. 2) (that is, the contract flag is “OFF”) (S16). That is, in this step, a service that corresponds to a high-interest service and is not being provided to the customer is extracted as a proposal target service for the customer. If the service has a high score and is not being provided but is prohibited from being provided to the customer due to the limitation on the provision of the service (for example, the limitation of the service providing area), the proposal target service determining part 314 does not select the service as the proposal target service. When the proposal target service determining part 314 has extracted the proposal target service, the proposal target service determining part 314 reflects information on the extracted proposal target service on the information on the customer in the list screen that is provided by the list screen providing part 316 and on the information on the details screen of the customer that is provided by the details screen providing part 318 (S18). Thus, the list screen and the details screen that are provided to the user (sales representative of the provider company or the like) from the list screen providing part 316 and the details screen providing part 318 reflect the information on the proposal target service for each customer.

In the example described above, the proposal target service for the customer is selected from among the services that are not being currently provided to the customer (that is, the contract flag is “OFF”) but a service that is being currently provided to the customer may be selected as the proposal target service in a special case. Examples of the special case include a case in which the length of the remaining period to the expiration date of contract (that is, the end of the service providing period; see FIG. 2) is equal to or shorter than a predetermined threshold. In this case, the service is selected as the proposal target service to prompt the customer close to the expiration of the service providing period to renew or extend the contract. In this example, a service in which the length of the remaining period to the expiration date of contract is equal to or shorter than the predetermined threshold though the service is being provided may be assumed as a service that is “not being provided”. The threshold of the remaining period is not limited to a fixed or uniform value but may be a value that varies depending on the attribute of the customer.

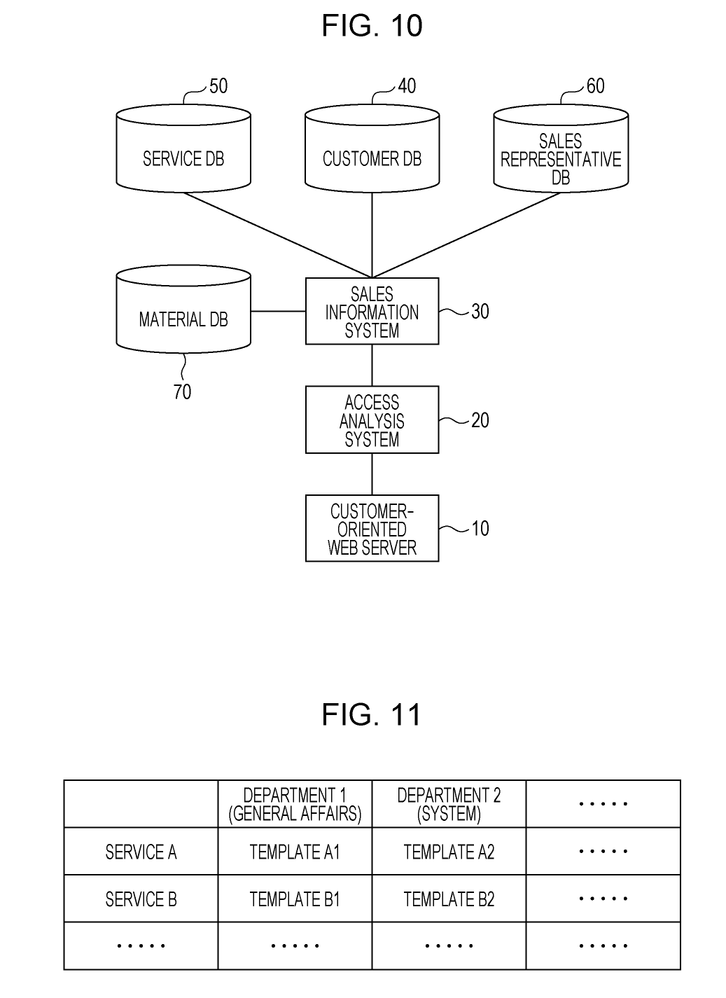

Next, description is given of a detailed example of a function of the sales information system 30 for generating a proposal material for the customer. As illustrated in FIG. 10, the system of this example includes a material DB 70 that may be used as a reference by the sales information system 30. The material DB 70 holds data to be used as a resource of the proposal material for the customer.

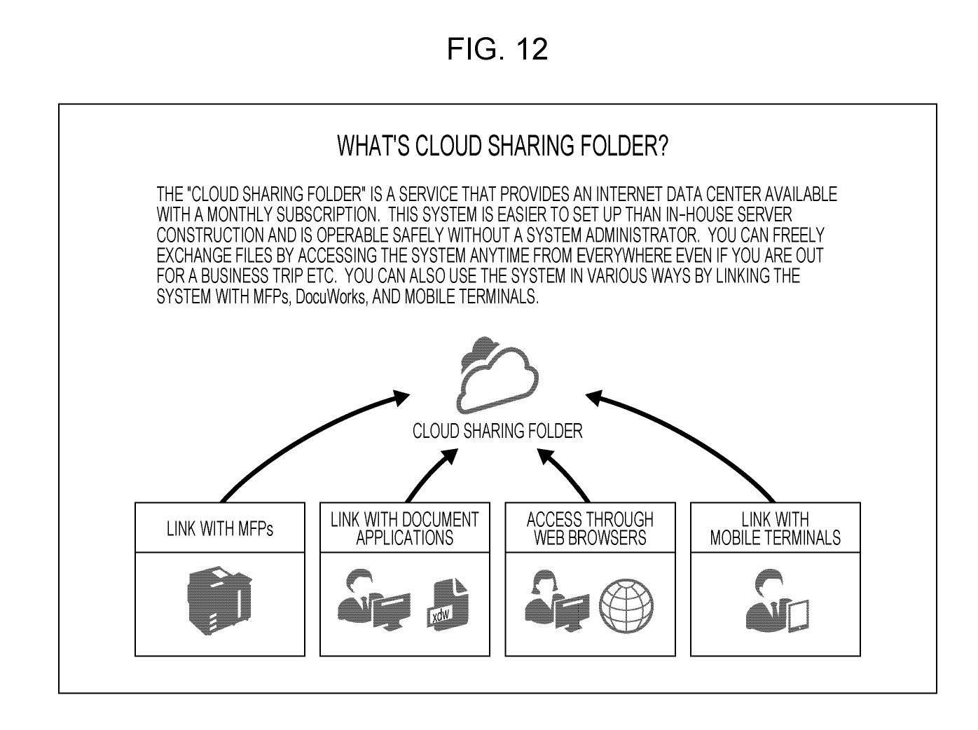

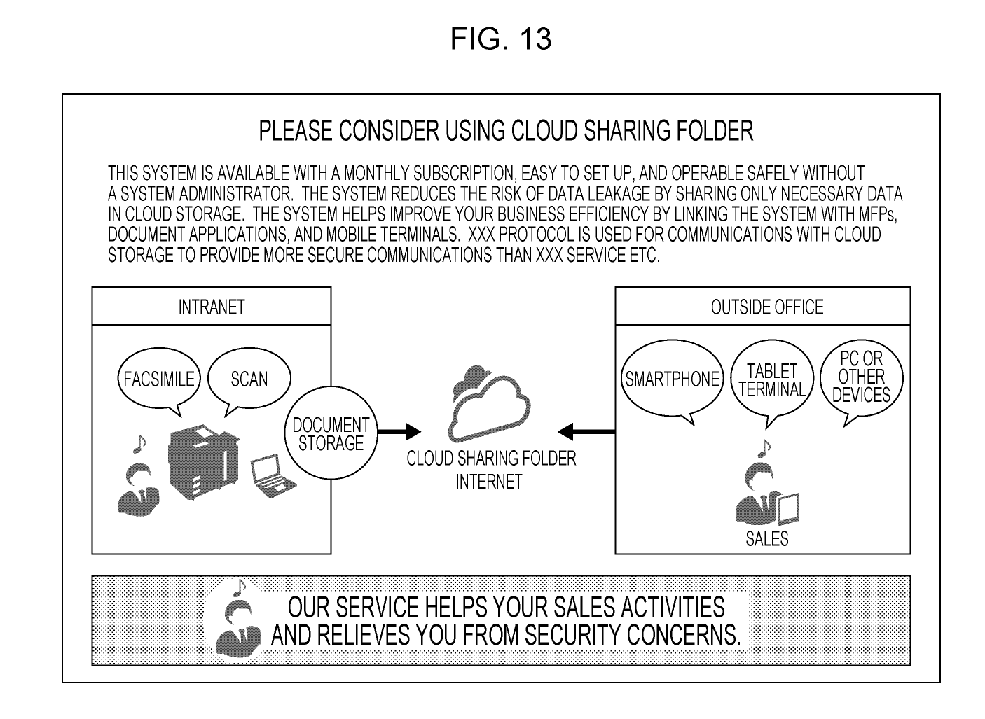

As an example of the data held in the material DB 70, FIG. 11 exemplifies templates for each combination of the service and the department of the customer. The template is a template of a document to be used for proposing introduction of the service to the customer and describes contents of the service, merits of introduction, and the like by using text and illustration. The contents of the template are different when the service is different. A material page of the service that is customized for the customer is generated by applying, for example, attribute information of the customer, such as a customer name, and a diagnosis result of the customer to the template. The department refers to a contact department of the customer (company or the like) to which the service is introduced (for example, a system department or a general affairs department). The same service has templates for the respective departments in order to cover a difference in literacy of the information system between the departments. For example, when the contact department of the customer is a system department that manages the information system, merits of introduction in a technical aspect are described by incorporating technical details of the proposal target service, such as security and examples of integration with other systems. When the contact department of the customer is a general affairs department, description of changes, effects, and the like owing to introduction of the service facilitates the understanding rather than the detailed description in a technical aspect. FIG. 12 illustrates an example of a proposal page of a “cloud sharing folder” service for the general affairs department. FIG. 13 illustrates an example of the proposal page of the “cloud sharing folder” service for the system department. When the proposal target service determining part 314 has selected the “cloud sharing folder” service as the proposal target service for the customer, the page exemplified in FIG. 12 or FIG. 13 is incorporated in the proposal material for the customer based on the contact department of the customer. In the proposal materials for the customer, the templates for the respective contact departments of the customer may similarly be prepared for pages of the services other than the proposal target service.

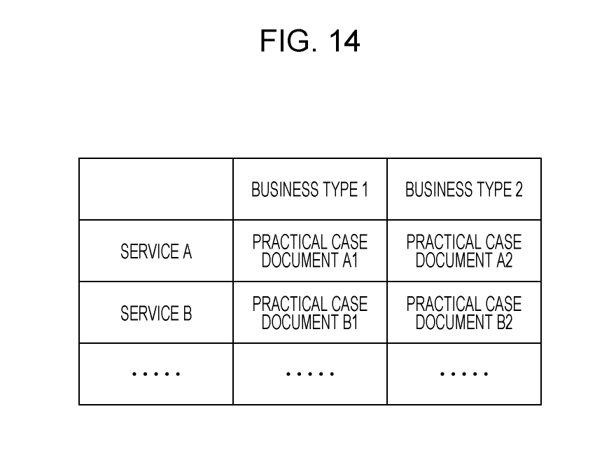

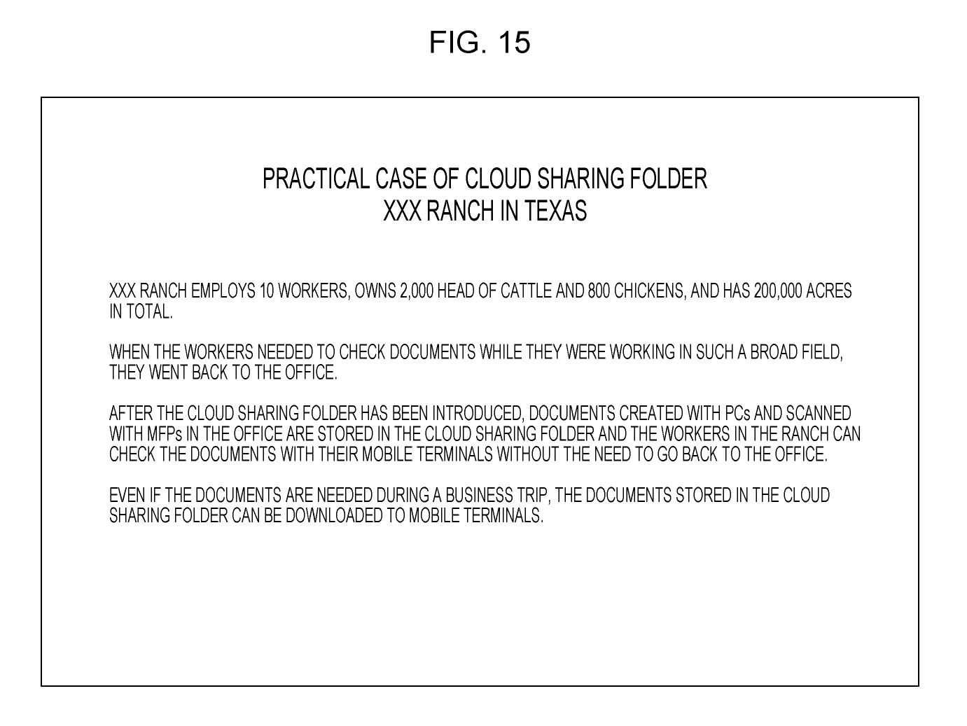

As another example of the data held in the material DB 70, FIG. 14 exemplifies practical cases of a service for each combination of the service and the business type of the customer. A practical case of a certain service for an existing customer is effective reference information when other customers determine whether to introduce the service. In particular, a practical case of a different customer of the same business type is most effective as a reference for a customer that is under consideration of introduction of the service. In this example, practical cases of the service are organized into a database for each combination of the service and the business type. The sales information system 30 searches the material DB 70 for a practical case corresponding to a business type of a customer (searchable in the customer DB 40) about a service selected as a proposal target service for the customer by the proposal target service determining part 314 and incorporates a page of the practical case in a proposal material for the customer. For example, FIG. 15 illustrates an example of a page that describes a practical case of the “cloud sharing folder” service in a business type “agriculture” or “ranching”.

The above description is directed to the example in which the contents of the page to be incorporated in the proposal material for the customer are changed based on the contact department or the business type of the customer. The page may similarly be changed based on an attribute of the customer other than the contact department or the business type. Examples of the attribute of the customer that is used as a reference for the changing include the size of the customer (distinction such as a large company, a midsize company, a small company, or a sole proprietor).

The exemplary embodiment described above is directed to the example in which the system of the exemplary embodiment of the present invention is applied to the system that provides information on a customer (in particular, information on a service to be proposed to the customer) to a user in a provider company (sales representative in the company or the like). The characteristic processing that involves identifying products in which the customer is presumed to have interest based on a history of view of an information item such as a web page by the customer and providing information on a product that is not being currently provided to the customer among the identified products is also applicable to systems of other types. For example, an E-commerce site has a product recommending function that involves identifying products in which the customer may have interest based on a history of customer's purchase on the site and a history of view of product information and providing information items on the identified products as recommended products on, for example, a web page that is viewed by the customer. The characteristic processing described above may be applied to the recommending function. In this case, as the recommended product to be incorporated by the recommending function in the web page that is viewed by the customer on the E-commerce site, a product that is not being provided to the customer is selected from among the products identified based on the customer's view history. Whether each product is being provided to the customer may be determined based on whether the product is recorded as being “purchased” in the customer's purchase history. A product recorded as being “purchased” is a product that is “being provided” and a product having no such record is a product that is “not being provided”.

The products to be prepared for sales on the E-commerce site include consumable items such as ink, toner, and print paper of printers. In general, the consumable items run out through the use for a certain period after the purchase and therefore need to be purchased again. Thus, when a product recorded as being “purchased” in the customer's purchase history corresponds to the consumable item, the system (for example, a system corresponding to the proposal target service determining part 314) assumes that the product is “not being provided” after a predetermined period (for example, a period slightly shorter than a standard usable period of the product (period before the product runs out)) has elapsed from the latest date of sales of the product and permits the product to be selected as a product recommended to the customer. The “predetermined period” of this example may be uniform in accordance with the type of the consumable item or may be defined based on a period that is determined based on information provided to the provider company from the customer for diagnosis or the like and ranges from a time when the customer starts to use the consumable item to a time when the customer runs out of the consumable item.

The system of the exemplary embodiment described above and the subsystems such as the sales information system that configurates this system are implemented by causing a computer to execute a program that represents the respective functions of the system. For example, the computer has, as hardware, a circuit configuration in which a microprocessor such as a CPU, memories (first memories) such as a random-access memory (RAM) and a read-only memory (ROM), a controller that controls fixed memories such as a flash memory, a solid-state drive (SSD), and a hard disk drive (HDD), various input/output (I/O) interfaces, and a network interface that controls connection to a network such as a local area network are connected via a bus. The program that describes details of the processing of the functions is stored in the fixed memory such as the flash memory via the network or the like and is installed in the computer. The group of functional modules exemplified above is implemented in such a manner that the program stored in the fixed memory is read in the RAM and is executed by the microprocessor such as the CPU.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display apparatus that acquires a history of view of information items related to products by a customer and information indicating a product that is not being provided to the customer or/and information indicating a product that is being provided to the customer, and displays, by using the history and the information, information related to the product that is not being provided to the customer among the products identified based on the history.

2. The display apparatus according to claim 1, wherein the display apparatus avoids displaying information related to the product that is being provided to the customer among the products identified based on the history.

3. The display apparatus according to claim 2,
wherein an expiration date of provision is set for each of the products, and
wherein the display apparatus displays the information related to the product that is being provided to the customer among the products identified based on the history when a remaining period to the expiration date of provision of the product is equal to or shorter than a threshold.

4. The display apparatus according to claim 2, wherein the display apparatus displays the information related to the product that is being provided to the customer among the products identified based on the history when the product that is being provided to the customer is a consumable item and a predetermined period has elapsed from a start of provision of the product.

5. The display apparatus according to claim 1, wherein the display apparatus avoids displaying the information related to the product that is not being provided to the customer among the products identified based on the history when the product corresponds to a product that is prohibited from being provided to the customer.

6. The display apparatus according to claim 1, wherein the display apparatus displays the information related to the product that is not being provided to the customer among the products identified based on the history so that the information is distinguishable from information related to the product that is being provided to the customer among the products identified based on the history.

7. The display apparatus according to claim 1, wherein the display apparatus displays, for a person other than the customer, the information related to the product that is not being provided to the customer among the products identified based on the history.

8. The display apparatus according to claim 7,
wherein the person other than the customer is a representative person who handles sales for the customer, and
wherein the display apparatus displays, for the representative person, the information related to the product that is not being provided to the customer among the products identified based on the history of the customer handled by the representative person.

9. The display apparatus according to claim 7, wherein the display apparatus includes a display that displays a list screen for a first-type customer who has the product that is not being provided to the customer among the products identified based on the history.

10. The display apparatus according to claim 9, wherein display items for the first-type customer in the list screen include a link for activating display of the information related to the product that is not being provided to the customer among the products identified based on the history of the first-type customer.

11. The display apparatus according to claim 10,
wherein the list screen includes a second-type customer who does not have the product that is not being provided to the customer among the products identified based on the history of the customer, and
wherein the first-type customer is displayed in a higher place in the list screen than the second-type customer.

12. The display apparatus according to claim 10,
wherein the list screen includes a second-type customer who does not have the product that is not being provided to the customer among the products identified based on the history of the customer, and
wherein the first-type customer is displayed so as to be distinguishable from the second-type customer.

13. The display apparatus according to claim 1, wherein the display apparatus includes a generator that generates a material for the customer, which includes proposal information on the product that is not being provided to the customer among the products identified based on the history of the customer.

14. The display apparatus according to claim 13, wherein the generator generates the material including the proposal information based on an attribute of the customer.

15. The display apparatus according to claim 14,
wherein the attribute of the customer is a business type of the customer, and
wherein the generator generates the material including, as the proposal information, information on a practical case in the business type of the customer about the product that is not being provided to the customer among the products identified based on the history of the customer.

16. The display apparatus according to claim 1, wherein the display apparatus displays, for the customer, the information related to the product that is not being provided to the customer among the products identified based on the history.

17. A non-transitory computer readable medium storing a program causing a computer to execute a process comprising:
acquiring a history of view of information items related to products by a customer;
acquiring information indicating a product that is not being provided to the customer or/and information indicating a product that is being provided to the customer; and
displaying, by using the history and the information, information related to the product that is not being provided to the customer among the products identified based on the history.

18. A display apparatus, comprising:
means for acquiring a history of view of information items related to products by a customer and information indicating a product that is not being provided to the customer or/and information indicating a product that is being provided to the customer; and
means for displaying, by using the history and the information, information related to the product that is not being provided to the customer among the products identified based on the history.
